(19) United States
(12) Patent Application Publication
(10) Pub. No.: US 2021/0349883 A1
(43) Pub. Date: Nov. 11, 2021

(54) AUTOMATED, USER-DRIVEN CURATION AND COMPILATION OF MEDIA SEGMENTS

(71) Applicant: AT&T Intellectual Property I, L.P., Atlanta, GA (US)

(72) Inventors: Subhabrata Majumdar, Jersey City, NJ (US); Deirdre Paul, Morristown, NJ (US); Eric Zavesky, Austin, TX (US)

(21) Appl. No.: 16/867,479

(22) Filed: May 5, 2020

(51) Int. Cl. G06F 16/23; G06F 16/22; H04N 21/466

(52) U.S. Cl. CPC G06F 16/2379; H04N 21/4667; G06F 16/2228

(57) ABSTRACT

An example method performed by a processing system includes computing a time series based on user consumption records for an item of media content, wherein the time series indicates, for each time segment of a plurality of time segments of the item of media content, a corresponding level of user interest, detecting a plurality of outliers in the plurality of time segments, based on the time series, and compiling a subset of the plurality of outliers into a single stream of events, wherein a duration of the single stream of events is shorter than a duration of the item of media content.

The present disclosure relates generally to media distribution, and relates more particularly to devices, non-transitory computer-readable media, and methods for curating and compiling segments of media in an automated, user-driven manner.

### BACKGROUND

Consumers (e.g., users of media content, hereinafter also referred to as simply “users”) are being presented with an ever increasing number of services via which media content can be accessed and enjoyed. For instance, streaming video and audio services, video on demand services, and the like are offering more forms of content (e.g., short-form, always-on, raw sensor feed, etc.) and a greater number of distribution channels (e.g., mobile channels, social media channels, streaming channels, just-in-time on-demand channels, etc.) than have ever been available in the past. As the number of choices available to users increases and diversifies, service providers seeking to retain their customer bases are looking to ways to increase the engagement of their customers with their content.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for curating and compiling segments of media in an automated, user-driven manner may operate;

FIG. 2 illustrates a flowchart of an example method for detecting salient segments of media in an automated manner, in accordance with the present disclosure;

FIG. 3 illustrates an example time series that plots, over time, a percentage of viewers of a program who re-watched various segments of the program (e.g., using a digital video recorder); and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for curating and compiling segments of media in an automated manner. In one example, a method performed by a processing system including at least one processor includes computing a time series based on user consumption records for an item of media content, wherein the time series indicates, for each time segment of a plurality of time segments of the item of media content, a corresponding level of user interest, detecting a plurality of outliers in the plurality of time segments, based on the time series, and compiling a subset of the plurality of outliers into a single stream of events, wherein a duration of the single stream of events is shorter than a duration of the item of media content.

In another example, a non-transitory computer-readable medium may store instructions which, when executed by a processing system in a communications network, cause the processing system to perform operations. The operations may include computing a time series based on user consumption records for an item of media content, wherein the time series indicates, for each time segment of a plurality of time segments of the item of media content, a corresponding level of user interest, detecting a plurality of outliers in the plurality of time segments, based on the time series, and compiling a subset of the plurality of outliers into a single stream of events, wherein a duration of the single stream of events is shorter than a duration of the item of media content.

In another example, a device may include a processing system including at least one processor and a non-transitory computer-readable medium storing instructions which, when executed by the processing system when deployed in a communications network, cause the processing system to perform operations. The operations may include computing a time series based on user consumption records for an item of media content, wherein the time series indicates, for each time segment of a plurality of time segments of the item of media content, a corresponding level of user interest, detecting a plurality of outliers in the plurality of time segments, based on the time series, and compiling a subset of the plurality of outliers into a single stream of events, wherein a duration of the single stream of events is shorter than a duration of the item of media content.

As discussed above, as the number of services via which users may access media content increases and diversifies, service providers seeking to retain their customer bases are looking to ways to increase the engagement of their customers with their content. One popular approach used by video distribution services has been to present viewers with sequences of curated video segments comprising the “highlights” of a program. Typically, these video segments are manually extracted by human operators (who typically determine which segments are most likely to be most interesting to viewers based on experience and/or domain knowledge), identified through analysis of video components and metadata (e.g., detecting facial expressions or crowd noise in the content which are assumed to be indicative of excitement, or identified through analysis of secondary data such as social media trends (e.g., segments being shared or discussed in social media). Although these approaches are generally successful in identifying the most popular content segments, these approaches are also costly in terms of resource usage and response latency. Moreover, due to resource and/or data constraints, only the most popular videos and the videos with the applicable metadata can be analyzed to produce curated video segments.

Moreover, the personalization of these approaches tends to be limited. That is, while these approaches may identify the content segments that are most interesting to the greatest number of viewers (or to the average viewer), these approaches are less effective when it comes to identifying the content segments that are likely to be the most interesting to a specific viewer. Even comparing the content segments to viewer demographic data or prior activity (e.g., web browsing habits, purchase history, social media activity, etc.) may not provide the level of desired personalization, since the demographic data and prior activity tend not to be context- or environment-aware. That is, the demographic data and priority activity often fail to account for the viewer's actual video consumption behaviors on the same platform.

Examples of the present disclosure detect salient segments of media content (e.g., segments of high or low interest) based on one or more user engagement metrics that are computed from consumption data for the media content, where the salient segments comprise less than the entireties of the items of media content from which the segments are extracted. In other words, rather than predicting which segments of an item of media content are likely to be of the most or least interest to users, the disclosed approaches allow past user behavior to dictate the most or least interesting segments. The engagement metrics that drive the identification of the salient segments may consider a plurality of consumption habits, including the segments consumed by the greatest number of distinct users, the segments subject to the greatest number of repeated consumptions (e.g., repeated watches, repeated listens, etc.), the points in the media content at which the greatest number of users begin or stop consuming.

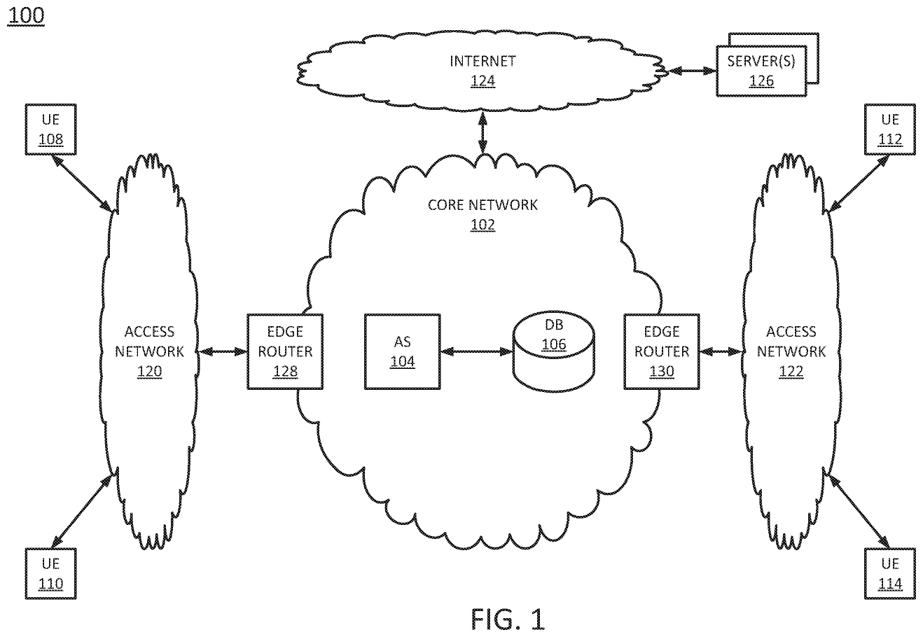

Once the salient segments have been detected based on the user engagement metrics, the salient segments may be combined to form a sequence of interesting segments of the item of media content (e.g., similar to a “highlight reel,” but where the users dictate the highlights based on engagement). Although examples of the present disclosure are discussed within the context of video content, it will be appreciated that the examples disclosed herein may be used to detect the most salient segments of any type of media, including audio and text-based media such as music, podcasts, audiobooks, electronic books, and the like. Thus, examples of the present disclosure may be used to detect segments that are of the greatest interest to users, even when those segments may not be the segments that are expected to be of the most interest. Similarly, the segments that are of the least interest may also be detected, which may allow the content creator to modify the media content to improve engagement. These and other aspects of the present disclosure are discussed in greater detail below in connection with the examples of FIGS. 1-4.

To further aid in understanding the present disclosure, FIG. 1 illustrates an example system 100 in which examples of the present disclosure for curating and compiling segments of media in an automated, user-driven manner may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider. The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like.

In one example, one or more servers 126 may be accessible to user endpoint devices 108, 110, 112, and 114 via Internet 124 in general. The server(s) 126 may operate in a manner similar to the AS 104, which is described in further detail below.

In accordance with the present disclosure, the AS 104 and DB 106 may be configured to provide one or more operations or functions in connection with examples of the present disclosure for curating and compiling segments of media in an automated manner, as described herein. For instance, the AS 104 may be configured to operate as a Web portal or interface via which a user endpoint device, such as any of the UEs 108, 110, 112, and/or 114, may access an application that allows items of media content to be analyzed for salient segments and/or allows salient segments to be compiled.

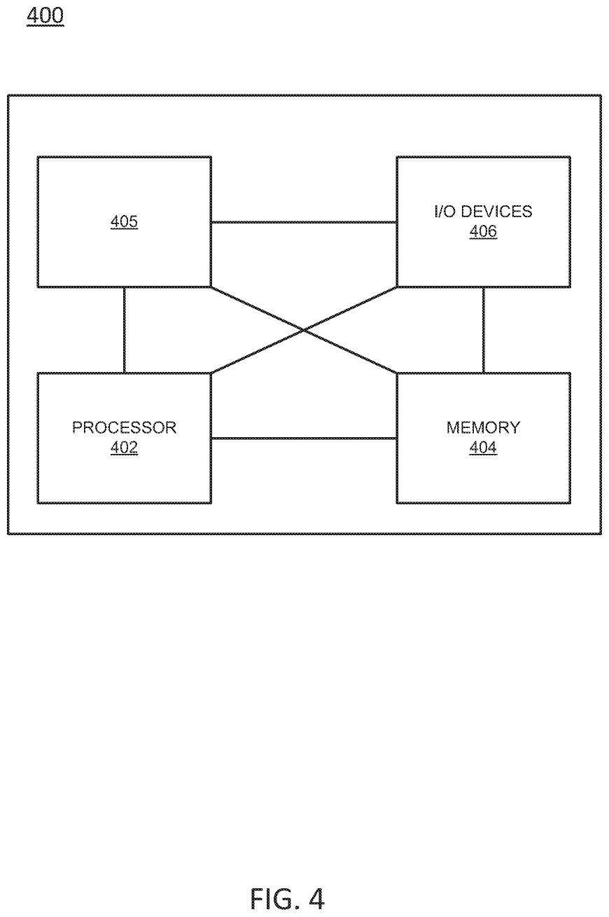

To this end, the AS 104 may comprise one or more physical devices, e.g., one or more computing systems or servers, such as computing system 400 depicted in FIG. 4, and may be configured as described above. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

For instance, in one example, the AS 104 may calculate a time series that plots some user engagement metric over time for an item of media content, based on raw user consumption data for the item of media content. The AS 104 may identify, based on the time series, outliers or time segments of the item of media content for which a value of the user engagement metric is especially high or especially low (e.g., some threshold amount higher or lower than an average, mean, or median value for the user engagement metric over the item of media content). In further examples, the AS 104 may extract a plurality of the outliers from the item of media content and compile the outliers into a single continuous stream. For instance, a plurality of outliers for which the user engagement metric was especially high may be compiled to form a “highlight reel” for the item of media content, which may be used as a teaser or preview to improve user engagement with the item of media content. Conversely, a plurality of outliers for which the user engagement metric is especially low may be compiled for review by the creator of the item of media content, so that the creator may modify the item of media content to improve user engagement.

The AS 104 may have access to at least one database (DB) 106, where the DB 106 may store raw user consumption data associated with items of media content which have been consumed by users. For instance, the raw consumption data may contain information about the conditions under which the items of media content were consumed (e.g., who, when, and how), profile data for the users who consumed the items of media content (e.g., demographic data, subscription data or history, number of set top boxes associated with the users' account), consumption histories of the users who consumed the items of media content (e.g., preferred genres, viewing modes, sports teams), preferences of the users who consumed the items of media content (e.g., likes dogs, dislikes violence, favorite actors), data indicating attention paid by the users who consumed the items of media content to the items of media content (e.g., user presence, facial or ocular tracking, other applications or media running on the same device or display while the item of media content is being consumed).

In further examples, the raw consumption data may contain information about situational or environmental features surrounding the consumption of the items of media content (e.g., location, traveling status, day, time of day, competing stimuli such as other devices playing other items of media content), program data for the item of media content (e.g., the genre of the item of media content, the network or channel on which the item of media content was distributed, the part of day during which the item of media content was first broadcast or otherwise made available for consumption, whether the item of media content is a new item or a repeated item, a season number associated with the item of media content, a director of the item of media content, an actor or performer appearing in the item of media content, a number of advertisements occurring in the item of media content, the products or services advertised in the advertisements, the advertisers associated with the advertisements, metadata tags associated with the item of media content (indicating, for instance, detected objects, recognized faces, voices, or names, scene descriptions, tone, silence, dialog-derived variables, or the like), publicly available metrics associated with the item of media content (e.g., ratings, number of user shares, user and/or critic reviews), and/or other variables provided by the producer of the item of media content (e.g., filming or recording locations, scene boundaries, etc.)).

In further examples, the DB 106 may store the time series calculated by the AS 104, the outliers that are identified based on the time series, and/or streams comprising compilations of outliers.

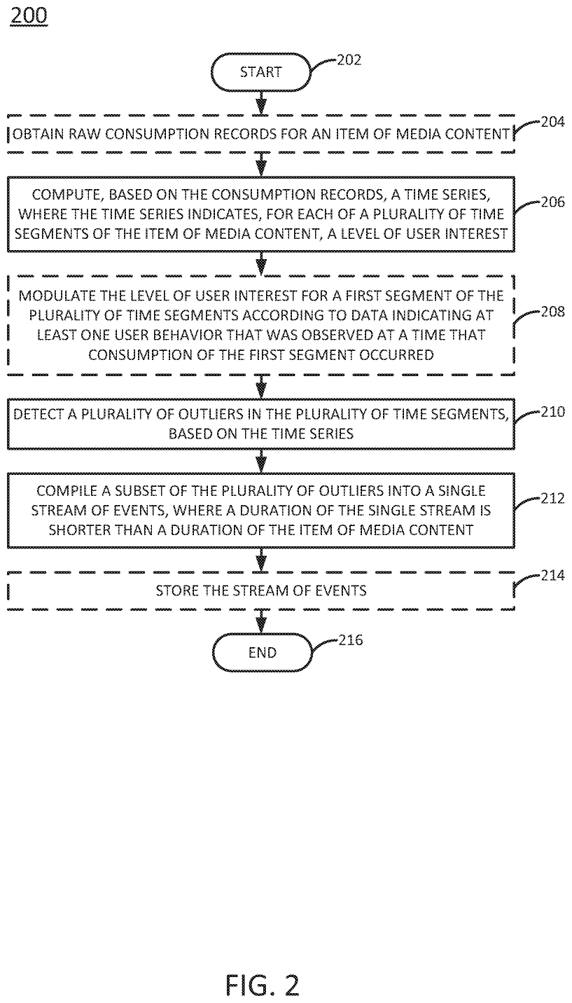

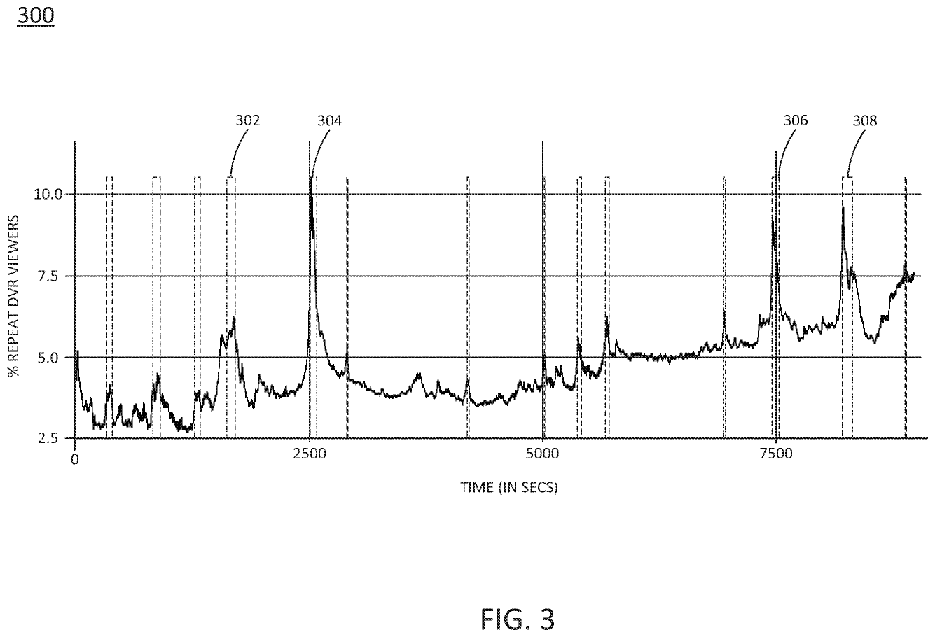

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for curating and compiling segments of media in an automated manner, as described herein. An example method for curating and compiling segments of media in an automated manner is described in greater detail below in connection with FIGS. 2-3.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for detecting salient segments of media in an automated manner, in accordance with the present disclosure. In one example, steps, functions and/or operations of the method 200 may be performed by a device as illustrated in FIG. 1, e.g., AS 104 or any one or more components thereof. In one example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system, such as processing system 402.

The method 200 begins in step 202 and proceeds to step 204. In optional step 204 (illustrated in phantom), the processing system may obtain raw consumption records for an item of media content. As described above, the item of media content may be an audiovisual media (e.g., a movie, an episode of the television series, a sports broadcast, or the like), an audio media (e.g., an album, a podcast, an audiobook, or the like), a text media (e.g., an electronic book, a blog, or the like), and/or any other types of media content. The consumption records may be obtained from a plurality of users who have all consumed the item of media content within some defined window of time prior to the obtaining (e.g., within the last x hours, days, or the like).

The consumption records may contain information about the conditions under which the item of media content was consumed (e.g., who, when, and how). For instance, in one example, the consumption records for the item of media content may include at least the following information: a user identifier (e.g., an identifier of the household, device, or person involved in the consumption of the item of media content), a mode via which the item of media content was consumed (e.g., live, digital video recorder, video on demand, streaming, or the like for audiovisual media), times (e.g., timestamps) at which consumption of the item of media content began and ended, and an identifier of the item of media content (e.g., data provider identifier, name of program, episode name or number, genre, etc.).

In a further example, the consumption records may further include at least one of the following types of information: profile data for the user who consumed the item of media content (e.g., demographic data, subscription data or history, or number of set top boxes associated with the user's account), consumption history of the user who consumed the item of media content (e.g., preferred genres, viewing modes, or sports teams), preferences of the user who consumed the item of media content (e.g., likes dogs, dislikes violence, or favorite actors), data indicating attention paid by the user who consumed the item of media content to the item of media content (e.g., user presence, facial or ocular tracking, other applications or media running on the same device or display while the item of media content is being consumed), the context for the device on which the item of media content was consumed (e.g., whether the item of media content was consumed while the user was in transit, during a meeting, while running, while at work, etc.) and environmental features surrounding the consumption of the item of media content (e.g., location, traveling status, day, time of day, competing stimuli such as other devices playing other items of media content).

In a further example, the consumption records may further include program data for the item of media content that was consumed. The program data may include general descriptors applicable to the entire item of media content or may be associated with specific time segments of the item of media content. For instance, the program data may include at least one of the following types of information: the genre of the item of media content, the network or channel on which the item of media content was distributed, the part of day (e.g., morning, afternoon, night) during which the item of media content was first broadcast or otherwise made available for consumption, whether the item of media content is a new item or a repeated item (e.g., a recording or re-rerun of a previously broadcast item of media content), a season number associated with the item of media content, a director of the item of media content, an actor or performer appearing in the item of media content, a number of advertisements occurring in the item of media content, the products or services advertised in the advertisements, the advertisers associated with the advertisements, metadata tags (e.g., video-, audio, and/or text-based metadata tags) associated with the item of media content (indicating, for instance, detected objects, recognized faces, voices, or names, scene descriptions, tone, silence, dialog-derived variables, or the like), publicly available metrics associated with the item of media content (e.g., ratings, number of user shares, user and/or critic reviews), and/or other variables provided by the producer of the item of media content (e.g., filming or recording locations, scene boundaries, etc.).

In step 206, the processing system may compute, based on the consumption records, a time series, where the time series indicates, for each of a plurality of time segments of the item of media content, a level of user interest (i.e., interest among a group of users, as opposed to a single user). In one example, each time segment may comprise a segment of the item of media content that spans a specific period of time (e.g., x seconds or x frames). In one example, each time segment may have the same duration or length. The level of user interest may quantify how interested a plurality of users who consumed the item of media content were in a corresponding segment of the item of media content.

In one example, the level of interest may be gauged in accordance with at least one of a plurality of per-segment user engagement metrics. In one example, the user engagement metrics may include at least one of: a number of times the segment was consumed (overall and by each mode of consumption), a number of unique users who have consumed the segment (overall and by each mode of consumption), a number of times each user who has consumed the segment consumed the segment (e.g., a ratio of views per viewer, listens per listener, reads per reader, etc.), a number of users who have consumed the segment more than once, a number of repeat consumptions of the segment, a number of viewers who tuned into or away from the segment, and a number of viewers who tuned into or away from the segment and later returned or left within a threshold period of time (or did not return or leave at all).

In one example, the user engagement metrics include a number of users (e.g., households or individual accounts) that consumed the full duration of a time segment (e.g., watched an entire segment of a television show, listened to an entire segment of a radio broadcast, etc.) more than once along a sliding window across the duration of the item of media content. For instance, x number of households may have re-watched a specific scene of a live sports broadcast at least y times over the duration of the broadcast. A higher value of x in this case may indicate that a greater number of users repeatedly tuned in before and tuned out after the scene (relative to other scenes). The greater number of re-watches may indicate that a particular time segment is especially exciting or interesting, or that the particular time segment is confusing in some way (e.g., the audio is hard to understand, the lighting makes it difficult to identify characters, etc.).

In another example, the user engagement metrics may include a percentage of households who stopped watching a time segment and did not return to view the item of media content for at least a predefined length of time. For instance, a number of households may have tuned out of an episode of a television show during a specific scene and not tuned back into the show for at least y minutes. A higher value of x in this case may indicate that a greater number of users found the scene uninteresting and/or offensive in some way.

FIG. 3, for instance, illustrates an example time series 300 that plots, over time, a percentage of viewers of a program who re-watched various segments of the program (e.g., using a digital video recorder). “Re-watched” in this context means that a viewer watched a segment at least two times. Time is measured in seconds along the x axis (e.g., where time t=0 indicates the start of the program), while the percentage of viewers is measured along the y axis. The example time series 300 comprises an actual time series that was calculated using raw viewership data for a televised soccer game.

In one example, any of the user engagement metrics described above may be computed as a percentage of a larger set of users over a longer period of time. Alternatively, any of the user engagement metrics may comprise an event count or a count of viewers as opposed to a percentage of users. In one example, any one or more of these user engagement metrics may be weighted, smoothed, or otherwise varied in terms of calculation.

Thus, the user engagement metrics may allow the processing system to identify relative differences in a user's behavior (e.g., user or device seasonality) with respect to segments of the item of media content where tune in and/or tune out is characterized. The user engagement metrics may also capture the effects of seasonality (e.g., time of day adjustments), market conditions (e.g., by designated marketing area; users in some markets may consume media at different times of day, or have longer average commutes during which the users consume media, etc.), other content events (e.g., recurring games by the same baseball team), and other real-world environmental events (e.g., weather events, new media releases, disasters, etc.).

In optional step 208 (illustrated in phantom), the processing system may modulate the level of user interest for a first segment of the plurality of time segments according to data indicating at least one user behavior that was observed at a time that consumption of the first segment occurred. For instance, a user engagement metric for the first segment may be adjusted upward or downward based on the at least one user behavior. In one example, the data indicating the at least one user behavior may include a device context while a user consumed the first segment, a location from which a user consumed the first segment, an activity in which a user was engaged while consuming the first segment, and/or whether other individuals were present when a user consumed the first segment. These factors may affect how closely a user pays attention to a time segment of the item of media content. In other examples, the data may comprise data from which these factors may be inferred, as opposed to explicit indications of the factors (e.g., the processing system can tell that the user was in transit, because the user was viewing a video on a mobile phone which pinged multiple different cell towers during the viewing).

In another example, the data indicating the at least one user behavior may include any interesting advertising was presented to a user during consumption of the first segment. For instance, in most cases, users may not pay close attention to, or may even skip (if consuming a recording, e.g., via a digital video recorder), commercials. However, during certain events (e.g., the Super Bowl), closer attention to commercials may be expected. In other examples, the data may comprise data from which these factors may be inferred, as opposed to explicit indications of the factors (e.g., the processing system can tell which advertisements were presented to a user who watched the Super Bowl, because the advertisements may be part of a predefined broadcast stream).

In another example, the data indicating the at least one user behavior may include a number of other items of media content that were available for consumption at the time that a user consumed the first segment. For instance, if the item of media content was consumed on a Sunday afternoon in the fall, the user may have chosen to consume the item of media content (and, more specifically, the first segment) over viewing any one of multiple football games, playoff baseball games, and/or other programming. In other examples, the data may comprise data from which these factors may be inferred, as opposed to explicit indications of the factors (e.g., the processing system can tell which programming was available to a user, because the programming may be part of a predefined broadcast stream for the user's geographic location).

In another example, the data indicating the at least one user behavior may include a cadence of an advertisement or a scene cut that was presented to a user while the user was consuming the item of media content (and more specifically, the first segment). For instance, an individual's behavior may vary based on how long the individual expects an interruption to an item of media content to last. As an example, if a television show advises that it will be “back in one minute” before breaking for commercials, or a streaming video service shows a countdown timer that indicates how long a commercial break will last, the individual may adjust an amount of time for which he or she is away from the viewing device accordingly. In other examples, the data may comprise data from which these factors may be inferred, as opposed to explicit indications of the factors.

In another example, the data indicating the at least one user behavior may include any previews for future media content that may have been presented to a user who consumed the item of media content (and more specifically, the first segment). For instance, if the item of media content is an episode of a television show which ends on a cliffhanger, the user may pay more attention than normal to a preview for the next episode. In other examples, the data may comprise data from which these factors may be inferred, as opposed to explicit indications of the factors.

In another example, the data indicating the at least one user behavior may include any metadata that corresponds to a situational awareness in the item of media content. For instance, if the item of media content is a live broadcast of a football game, and one team is in the red zone, or the clock is running down, then a user may pay closer attention during this time than other times. In other examples, the data may comprise data from which these factors may be inferred, as opposed to explicit indications of the factors.

In step 210, the processing system may detect a plurality of outliers in the plurality of time segments, based on the time series. In this context, an outlier may be a time segment of the plurality of time segments for which the associated level of user interest (e.g., user engagement metric) differs from (e.g., exceeds or falls below) some collective measure of user interest by at least a threshold amount. The collective measure may be, for instance, an average level of user interest, a mean level of user interest, a median level of user interest, or the like, as computed over the plurality of time segments. The threshold amount may comprise some unit of measure difference relative to the collective measure. Thus, an outlier may be a time segment for which the associated level of user interest is significantly higher or significantly lower than the collective measure (e.g., a portion of the item of media content for which interest is especially high or especially low). In another example, the outliers may comprise some fixed number of the time segments associated with the highest and/or lowest levels of user interest (e.g., the n highest and/or n lowest levels of user interest).

For instance, referring back to the time series 300 of FIG. 3 (which, as discussed above, is computed from actual raw viewership data for a televised soccer game), the level of user interest remains relatively steady for most of the item of media content. Specifically, the percentage of viewers who re-watched a time segment of the soccer game at any given time t hovers at or near a baseline of approximately 5.0%, and even dips as low as approximately 2.5% during the earliest portions of the game. However, the percentage increases suddenly during a plurality of segments, as indicated by a plurality of peaks 302, 304, 306, and 308.

The peaks 302, 304, 306, and 308 may comprise outliers as described above (i.e., in this case, time segments for which user interest was significantly higher than usual). The peaks 304, 306, and 308, occurring at approximately 2500 seconds, 7500 seconds, and 8000 seconds, respectively, represent goal scoring events (which are expected to be heavily re-watched segments of the game). During each these goal scoring events, the percentage of viewers who re-watched jumped to at least approximately 9.0%.

The peak 302, occurring early in the game at approximately 2000 seconds, represents a performance of the United States national anthem by a World War II veteran. A performance of the national anthem would not necessarily be an event that would be expected to be heavily re-watched in a soccer game (at least compared to a scoring event), but as the time series 300 shows, the performance of the national anthem during this particular soccer game compelled approximately 6.0% of viewers to re-watch (which, though not as high as during the goal scoring events, is at least approximately a one percentage point increase over the baseline for the soccer game as a whole and at least approximately a two to three percentage point increase over the immediately surrounding baseline, i.e., the baseline for the earlier portion of the soccer game).

In one example, anomaly detection methods may be used to detect time segments for which the level of user interest is unusually high or low compared to surrounding time segments (or to the item of media content overall). In another example, the time segments may be ranked or sorted according to some numerical measure of the level of user interest (e.g., a user engagement metric, as described above). In another example, interest level patterns may be learned by an unsupervised embedding of temporally adjacent values (e.g., semantic analysis of signals). In another example, temporally adjacent time segments can be merged or otherwise accentuated.

In some examples, detection of outliers may be adjusted to account for the preferences of a specific user or group of users. For instance, the threshold amount by which an outlier must be higher or lower than the collective measure may be adjusted to tune the detection of outliers for the specific user or group of users. As an example, if a user or group of users typically shows or expresses limited levels of excitement (e.g., rarely awards more than three stars out of five to items of media content), then the threshold amount by which an outlier must exceed the collective measure may be adjusted upward from a default value.

Referring back to FIG. 2, in step 212, the processing system may compile a subset of the plurality of outliers into a single stream of events, where a duration of the single stream is shorter than a duration of the item of media content. For instance, compiling the outliers for which the associated level of interest exceeds the collective measure by the threshold amount may result in the generation of a “highlight reel,” or stream of the most interesting time segments of the item of media content (based on level of user interest). Similarly, compiling the outliers for which the associated level of interest falls below the collective measure by the threshold amount may result in the generation of stream of the least interesting time segments of the item of media content (based on level of user interest).

The stream of events may comprise a sequence of time segments of the media stream, where the time segments are concatenated to form a single continuous media (e.g., in which the time segments may play one after the other). For instance, the stream of events may comprise a continuous sequence of video clips, audio clips, or the like. The stream of events in one example may comprise only the subset of the plurality of outliers. For instance, the stream of events may omit the portions of the item of media content that are not outliers.

In some examples, the subset of the plurality of outliers that is selected for compilation into the stream of events may be customized for a specific user or user demographic. For instance, users in a certain age group may find certain types of events to be more interesting than users in other age groups.

In optional step 214 (illustrated in phantom), the processing system may store the stream of events (e.g., in a database). The stream of events may later be distributed from its storage location to one or more users.

The method 200 may end in step 216.

Examples of the present disclosure therefore provide a way for content creators to improve user engagement with media content. For instance, time segments of an item of media content that previous users have found most interesting can be presented to prospective users as a “highlight reel,” in order to elicit the prospective users' interest in the item of media content. For instance, the portions of a television episode that were deemed most exciting by viewers on the East Coast of the United States (e.g., intense action sequences, appearances of fan favorite characters, etc.) may be extracted and compiled into a teaser to be presented to potential viewers on the West Coast (to whom the episode has not yet been presented).

An advantage of the present disclosure is that, because the detection of interesting time segments is user-driven (i.e., based on direct feedback of user reactions), scenes that were actually interesting to users, but which may not have been expected to be of particular interest to users, can be identified. For instance, during a soccer broadcast, one might understandably expect the goal scoring events to be the most interesting scenes to viewers. However, as illustrated by the time series 300 of FIG. 3, a particularly moving rendition of the national anthem performed prior to the game might have compelled a significant number of re-watches as well. Similarly, other relatively low-action events during the game, such as a camera shot of a celebrity sitting in the stands, a fan holding a funny sign, or the like, may also compel a significant number of viewers to re-watch portions of the broadcast. Thus, examples of the present disclosure may help to identify the portions of an item of media content that might not be the most intuitively interesting portions.

Alternatively, time segments that previous users have found least interesting can also be identified and presented to the content creator to potentially drive adjustments to the item of media content. For instance, the portions of a television episode that were deemed least exciting, or even objectionable, by viewers on the East Coast of the United States (e.g., an overlong monologue, a new character who was not well-received by the audience, an offensive scene, etc.) may be extracted and compiled for review by the content creator, who may remove and/or modify these time segments before the item of media content is presented to potential viewers on the West Coast.

In further examples, time segments of an item of media content for which user interest was especially high or especially low may be used as training data to train a machine learning model to recognize interesting (or uninteresting) content. For instance, time segments of the media content may be labeled as “interesting” or “not interesting” (or with a numerical score that indicates a level of interest along a range or scale) and used to train a supervised machine learning model. Output of the machine learning model may be used to guide creation of content that generates high levels of user interest.

In further examples, additional insight into user engagement with content may be derived by correlating time segments of high or low user interest with data from other sources. For instance, numbers or values of high/low time segments, the overall slope of a time series, or other features related to level of user interest may be correlated with measures of an item of media content's success from web site ratings, critic scores, viewership numbers or market ratings, and/or the like.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for curating and compiling segments of media in an automated manner, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner fora particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for curating and compiling segments of media in an automated manner (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for curating and compiling segments of media in an automated manner (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
computing, by a processing system including at least one processor, a time series based on user consumption records for an item of media content, wherein the time series indicates, for each time segment of a plurality of time segments of the item of media content, a corresponding level of user interest;
detecting, by the processing system, a plurality of outliers in the plurality of time segments, based on the time series; and
compiling, by the processing system, a subset of the plurality of outliers into a single stream of events, wherein a duration of the single stream of events is shorter than a duration of the item of media content.

2. The method of claim 1, wherein the item of media content is selected from the group of: an audiovisual media, an audio media, and a text-based media.

3. The method of claim 1, wherein the user consumption records are obtained from a plurality of users who have all consumed the item of media content within a defined window of time prior to the computing.

4. The method of claim 1, wherein the corresponding level of user interest is a measure of at least one selected from a group of: a number of times the each time segment was consumed, a number of unique users who have consumed the each time segment, a number of times each user who has consumed the each time segment consumed the each time segment, a number of users who have consumed the each time segment more than once, a number of repeat consumptions of the each time segment, a number of viewers who tuned into or away from the each time segment, and a number of viewers who tuned into or away from the each time segment and later returned or left within a threshold period of time.

5. The method of claim 1, wherein the corresponding level of user interest is a measure of a number of users who consumed a full duration of the each time segment more than once along a sliding window across the full duration of the item of media content.

6. The method of claim 1, wherein the corresponding level of user interest is a measure of a percentage of users who stopped watching the each time segment and did not return to view the item of media content for at least a predefined length of time.

7. The method of claim 1, further comprising, subsequent to the computing but prior to the detecting:
modulating, by the processing system, the level of user interest for a first time segment of the plurality of time segments, according to data indicating at least one user behavior that was observed at a time that consumption of the first time segment occurred.

8. The method of claim 7, wherein the at least one user behavior comprises at least one selected from a group of: a context in which a user consumed the first time segment, a location from which a user consumed the first time segment, an activity in which a user was engaged while consuming the first time segment, and whether other individuals were present when a user consumed the first time segment.

9. The method of claim 1, wherein each outlier of the plurality of outliers comprises a time segment of the plurality of time segments for which the corresponding level of user interest differs from a collective measure of user interest by at least a threshold amount.

10. The method of claim 9, wherein the corresponding level of user interest is greater than the collective measure of user interest.

11. The method of claim 9, wherein the corresponding level of user interest is less than the collective measure of user interest.

12. The method of claim 9, wherein the collective measure of user interest comprises one selected from a group of: an average level of user interest for the item of media content as computed over the plurality of time segments, a mean level of user interest for the item of media content as computed over the plurality of time segments, a median level of user interest for the item of media content as computed over the plurality of time segments.

13. The method of claim 12, wherein the detecting comprises:
applying, by the processing system, an anomaly detection technique to identify a peak in the time series.

14. The method of claim 9, further comprising:
adjusting, by the processing system, the threshold amount based on a user for whom the single stream of events is to be compiled.

15. The method of claim 1, wherein the plurality of outliers comprises a fixed number of the plurality of time segments associated for which the corresponding level of user interest is highest among all time segments of the plurality of time segments.

16. The method of claim 1, wherein the plurality of outliers comprises a fixed number of the plurality of time segments associated for which the corresponding level of user interest is lowest among all time segments of the plurality of time segments.

17. The method of claim 1, wherein the compiling comprises:
concatenating, by the processing system, time segments corresponding to the subset to form a continuous media.

18. The method of claim 17, wherein the subset of the plurality of outliers is selected based on an interest of a specific user demographic.

19. A non-transitory computer-readable medium storing instructions which, when executed by a processing system including at least one processor, cause the processing system to perform operations, the operations comprising:
computing a time series based on user consumption records for an item of media content, wherein the time series indicates, for each time segment of a plurality of time segments of the item of media content, a corresponding level of user interest;
detecting a plurality of outliers in the plurality of time segments, based on the time series; and
compiling a subset of the plurality of outliers into a single stream of events, wherein a duration of the single stream of events is shorter than a duration of the item of media content.

20. A device comprising:
a processing system including at least one processor; and
a non-transitory computer-readable medium storing instructions which, when executed by the processing system, cause the processing system to perform operations, the operations comprising:
computing a time series based on user consumption records for an item of media content, wherein the time series indicates, for each time segment of a plurality of time segments of the item of media content, a corresponding level of user interest;
detecting a plurality of outliers in the plurality of time segments, based on the time series; and
compiling a subset of the plurality of outliers into a single stream of events, wherein a duration of the single stream of events is shorter than a duration of the item of media content.
